(19) United States
(12) Patent Application Publication
(10) Pub. No.: US 2022/0237097 A1
(43) Pub. Date: Jul. 28, 2022

(54) PROVIDING USER EXPERIENCE DATA TO TENANTS

(71) Applicant: VMware, Inc., Palo Alto, CA (US)

(72) Inventors: Anar Khetarpal, Santa Clara, CA (US); Andrew Levy, Palo Alto, CA (US); Kieran Crawford, Palo Alto, CA (US); Phil Krasko, Palo Alto, CA (US)

(21) Appl. No.: 17/155,944

(22) Filed: Jan. 22, 2021

(51) Int. Cl. G06F 11/32; G06F 11/30; G06F 11/34; G06F 3/0482; G06F 21/31

(52) U.S. Cl. CPC G06F 11/323; G06F 11/3006; G06F 11/3051; G06F 2221/2139; G06F 3/0482; G06F 21/31; G06F 11/3409

(57) ABSTRACT

Systems and methods are described for exposing user experience data to tenants. A server can receive application data from an application executing on multiple user devices. The server can receive a signed credential that links the application data to its corresponding user device and a tenant associated with the user device. The server can extract data for a tenant using an identifier in the signed credentials. The server can insert the extracted data into a graphical user interface that displays the application data for the tenant.

### BACKGROUND

Enterprises implement Unified Endpoint Management (“UEM”) systems to manage user devices. UEM systems often provide managed applications to the user devices that employees can use while performing work functions on their user devices. For example, UEM systems can include email, directory, and word processing applications. The UEM provider often desires to understand how these applications are performing for end users. To do this, they can gather application data from the user devices, and using various metrics, display performance data or calculate user experience scores.

This performance data is aggregated across all devices managed by the UEM provider. However, UEM providers often have multiple clients that use their services and managed applications. One problem these providers can face is presenting performance and user experience data in a meaningful way to their clients. In other words, UEM providers are unable to present performance and user experience data to a client that is specific to that client. Additionally, UEM providers currently do not have a way of tracking application data by client for third-party applications provided by the UEM provider.

As a result, a need exists for presenting application data to multiple clients of an application in an actionable way.

### SUMMARY

Examples described herein include systems and methods for providing user experience data to tenants. In an example, an intelligence server can receive application data from an application executing on multiple user devices. The application data can include usage data, performance data, user behavior data, and device health data. Application data can include usage rates, crash rates, network error events, network latency, application response time, application loading time, user flow failures, virtual private network (“VPN”) performance data, and CPU and memory utilization of the application. Usage data can include when a user loads the application and total usage time. Device health information can include battery health, operating system crashes, boot time, shutdown time, and available storage.

The intelligence server can receive a signed credential with the application data. The signed credential can authenticate the source of the application data, identify the user device it came from, and identify a tenant that the user device is associated with. The tenant can be identified using a tenant identifier (“ID”). The intelligence server can group the application data by tenant ID. The intelligence server can then insert the data into a GUI that displays the application data associated with the tenant.

Users from the tenants, or tenant users, can access a version of the GUI that displays the application data for their corresponding tenant. For example, the GUI can be provided through a web portal that tenant users can access through a web browser. The credentials provided by a tenant user identify the user's tenant, and the GUI for that tenant is displayed for the user. In an example, the intelligence server can create an administrator (“admin”) view of the GUI that can display the application data for all the user devices. The admin view can also allow an admin user to view the GUI as seen from the tenant views.

In an example, the data can be collected by an intelligence agent installed on the user devices. The intelligence agent can contact a deployment server to obtain endpoint Uniform Resource Locators (“URLs”) for authenticating the user device and sending the application data. In one example, the deployment server can provide endpoint URLs that include a region code that causes the intelligence agent to authenticate and send application data to regional endpoints. The region code can be extracted by the intelligence server to allow tenants to view the application data by geographic region.

The intelligence agent can include a refresh token. The intelligence agent can send the refresh token to the authentication URL provided by the deployment server. An authentication server associated with the authentication URL can verify the refresh token and respond with an access token. In one example, the access token can be a signed credential. In an example, the intelligence agent can send the signed credential and application data that it collects to an event proxy endpoint URL received from the deployment server.

In one example, the event proxy URL can direct to the intelligence server. In another example, the intelligence agent can also, or in lieu of the intelligence server URL, receive an event proxy endpoint URL that directs to a regional event proxy server associated with the user device's tenant. The intelligence agent can send the application data to the regional tenant server, and the tenant server can send the data to an application server of the application owner. This can expose certain data directly to the tenant and the application owner.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is an illustration of an example system for providing user experience data to tenants.

FIG. 2 is a flowchart of an example method for providing user experience data to tenants.

FIG. 3 is a sequence diagram of an example method for providing user experience data to tenants.

FIG. 4 is second flowchart of an example method for providing user experience data to tenants.

FIG. 5 is a third flowchart of an example method for providing user experience data to tenants.

FIG. 6A is an illustration of an example graphical user interface (“GUI”) of a display used to provide user experience data to tenants.

FIG. 6B is an illustration of a second example GUI for providing user experience data to tenants.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for exposing user experience data to tenants. A server can receive application data from an application executing on multiple user devices. The server can receive a signed credential that links the application data to its corresponding user device and a tenant associated with the user device. The server can extract data for a tenant using an identifier in the signed credentials. The server can insert the extracted data into a graphical user interface that displays the application data for the tenant.

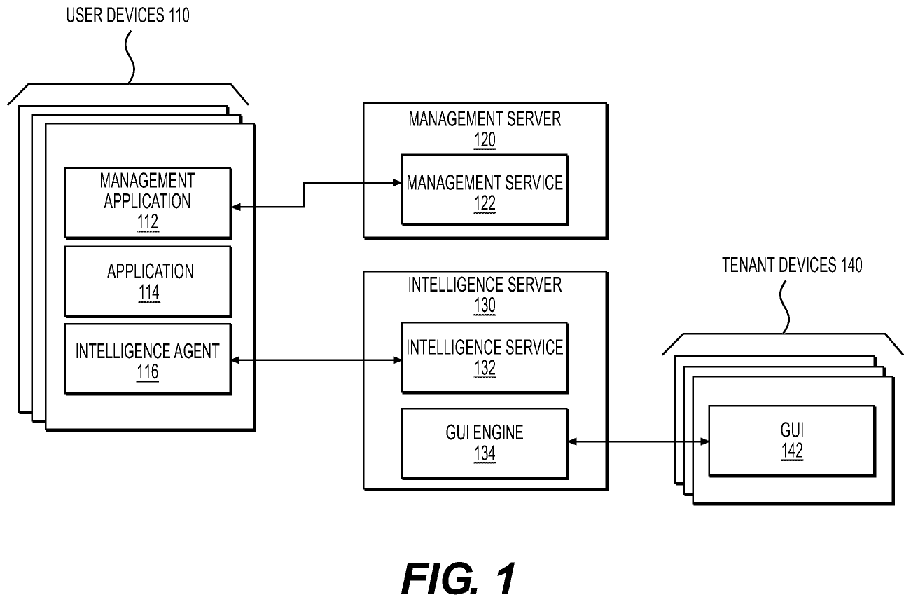

FIG. 1 is an illustration of a system for providing user experience data to tenants. In an example, the system can be a UEM system that manages user devices 110 for client organizations. For example, the system can manage user devices 110 through a management service 122 on a management server 120. The user devices 110 can be one or more processor-based devices, such as a personal computer, tablet, or cell phone. The management server 120 can be a single server or a group of servers, including multiple servers implemented virtually across multiple computing platforms. The management service 122 can manage the user devices 110 through a management application 112 installed on the user devices 110.

In an example, the management application 112 can be installed on the user devices 110 as part of an enrollment process. Enrolling with the management server 120 can grant the UEM management control over some or all of the user devices 110. The management application 112 can be a stand-alone application, part of an enterprise application, or part of an operating system of the user devices 110. The management application 112 can be responsible for ensuring that user devices are up to date with compliance and security settings prior to accessing enterprise data and resources. The management application 112 can communicate with the management service 122, allowing UEM management of user devices 110 based on compliance and security settings at the management server 120. The management application 112 can enforce compliance at the user device 110, such as by wiping enterprise data when compliance standards are not met. Example compliance standards can include ensuring a device is not jailbroken, that particular encryption standards are used in enterprise data transmission, that the device does not have certain blacklisted applications installed or running, and that the device is located within a geofenced area when accessing certain enterprise resources.

The user devices 110 can include an application 114. The application 114 can be a managed application, in an example. For example, the managed application 114 can allow an enterprise to control access and functionality of the application 114. Additionally, the application 114 can persist locally on the user device or can be accessed from within the management application 112, depending on the example. Even when the application 114 is accessed remotely, portions of that application 114 or data utilized by the application 114 can exist locally on the user device 110. Local resources can be encrypted and decrypted for use by the management application 112, managed application 114, or some other process of the UEMS.

In an example, the user devices 110 can include an intelligence agent 116. The management server 120 can provide the intelligence agent 116 to the user devices 110 as a software development kit (“SDK”). For example, the SDK can include methods for intelligence agent 116 operation that can be built into an application or operating system service using the SDK. In one example, the management application 112 can require that the intelligence agent 116 be installed on the user device as part of its compliance enforcement. In one example, the intelligence agent 116 can be installed as part of the management application 112, or part of an operating system of the user devices 110.

In an example, the intelligence agent 116 can be a tool for providing tools and application performance insights to the UEM or the owner of application 114. For example, the intelligent agent 116 can collect data on events that may indicate how the application 114 is performing. As some examples, the intelligence agent 116 can collect data on application usage rates, crash rates, network error events, network latency, application response times, application loading times, user flow failures, and CPU and memory utilization allocated to the application. The intelligence agent 116 can send this application data to an intelligence service 132 on an intelligence server 130. The intelligence server 130 can be a single server or a group of servers, including multiple servers implemented virtually across multiple computing platforms. In an example, the intelligence service 132 can send the application data as one or more a data files using an Application Program Interface (“API”) call or an Internet protocol, such as hypertext transfer protocol (“HTTP”), simple object access protocol (“SOAP”), representational state transfer (“REST”), and/or other protocols.

In one example, the intelligent agent 116 can send application data to a regional server, such as a server at a regional data center, of the user device's tenant. For example, when a user device 110 enrolls with a UEM, the management server 120 can provide a deployment URL and a refresh token that the intelligence agent 116 can contact to retrieve authentication and configuration information. For example, the deployment URL can lead to a deployment server that provides authentication and event proxy endpoints. In an example, the endpoint URLs can include a region code that identifies regional servers that the intelligence agent 116 should interact with. In one example, the regional URL can be associated with a tenant server in the region. The intelligence agent 116 can exchange the refresh token with the authentication endpoint to receive an access token. The intelligence agent 116 can send the access token with the application data to the regional event proxy server. In an example, the event proxy server can be a regional tenant for the user device's tenant ID. This can allow the application data to be routed to regional server of tenants so that the tenants can receive their corresponding application data. In one example, the tenant servers can send the data on to a server, such as a regional data center, of the application owner.

The intelligence service 132 can parse the application data and provide it to a GUI engine 134. This can include separating the data according to the user device's associated tenant. For example, the intelligence agent 116 can send an access token, like a signed credential, with the application data. The credential can authenticate the user device 110 and provide additional information that the intelligence service 132 can use to parse the application data. For example, the access token can include the user device's tenant ID. As part of the parsing process, the intelligence agent 116 can tag the application data with its associated tenant ID. In an example, the user devices 110 can include user devices 110 of various tenants, and the intelligence service 116 can use the tenant IDs to determine which application pertains to which tenant.

The GUI engine 134 can execute as one or more processes on the intelligence server 130. The GUI engine 134 can format application data for presentation to administrative users, with a goal of providing insight to those users regarding application or device functionality. The GUI engine 134 can generate a GUI 142 that is accessed by tenants, such as by connecting to the intelligence server 130 as a webserver.

The GUI engine 134 can insert the application data into a GUI 142 that it provides to tenant devices 140. The tenant devices 140 can be one or more processor-based devices associated with a tenant, such as a server, personal computer, tablet, or cell phone. In an example, the tenant devices can access the GUI 142 by logging in using authentication credentials. For example, the GUI 142 can be a web-based application that a tenant user can access via a web browser. The authentication credentials used to access the GUI 142 can indicate which tenant the tenant user is associated with. The GUI engine 134 can provide a GUI 142 to the tenant that only display application data for that tenant. In an example, the GUI 142 can include application data for each tenant enrolled with the UEM, and the tenant users can all be restricted to application pertaining to their tenant ID. In one example, the GUI engine 134 can aggregate the application data from all user devices 110, regardless of tenant, to provide a GUI 142 that displays the data for all users of the application 114. This version of the GUI 142 can be restricted to select user groups, such as administrators (“admins”) of the UEM, tenant, or the application owner.

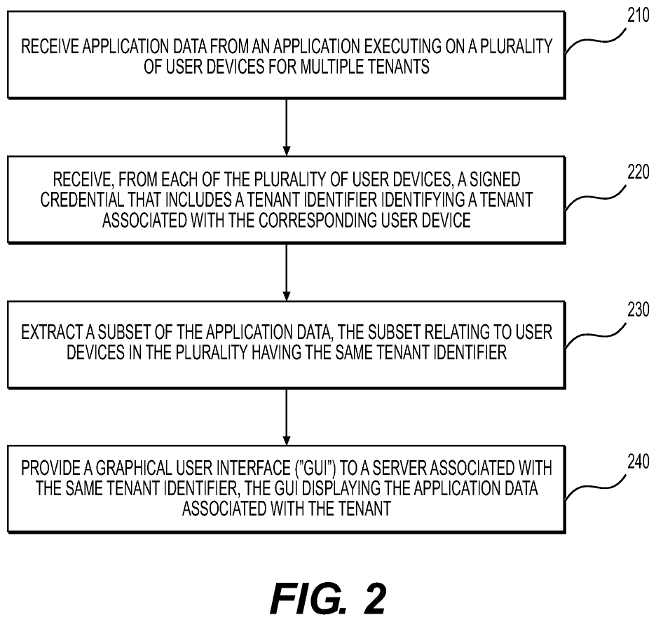

FIG. 2 is a flowchart of an example method for providing user experience data to tenants. At stage 210, the intelligence server 130 can receive application data from the application 114 executing on the user devices 110. In an example, the intelligence agent 116 installed on the user devices can collect data relating to the application 114. Some examples of data collected by the intelligence agent 116 can include application performance data, usage data, user behavior data, and device health information. Application data can include usage rates, crash rates, network error events, network latency, application response time, application loading time, user flow failures, VPN performance data, and CPU and memory utilization of the application 114. Usage data can include when a user loads the application and total usage time. Device health information can include battery health, operating system crashes, boot time, shutdown time, and available storage.

The VPN performance data can provide important insights into an application's performance for a tenant or application owner. For example, a UEM can require a VPN connection to utilize the managed application 114. Therefore, the application's 114 performance can be dependent on the quality of the user device's 110 VPN connection. For that reason, the VPN performance data can be key to determining how the application 114 is actually performing.

The intelligence agent 116 can send this information to the intelligence service 132. In an example, the intelligence service 132 can send the application data as one or more a data files using an API call or an Internet protocol, such as HTTP, SOAP, REST, and/or other protocols.

At stage 220, the intelligence server 130 can receive, from each of the user devices 110, a signed credential that includes a tenant ID identifying a tenant associated with the corresponding user device. For example, the intelligence server 130 can be associated with the UEM of the management server 120. The UEM can manage user devices 110 for multiple tenants. When a user device 110 enrolls with the UEM, the management service 122 can provide the user devices 110 with a unique signed credential that includes a tenant ID of the corresponding tenant. The intelligence agent 116 can send its signed credential to the intelligence agent 132 with the application data. The intelligence agent 132 can use the signed credential to authenticate the user device 110 and determine which tenant the application data corresponds to. In an example, the signed credential can be a JavaScript Object Notation (“JSON”) Web Token (“JWT”).

At stage 230, the intelligence server 130 can extract a subset of the application data relating to user devices that have a like tenant identifier. For example, as the intelligence server 130 receives the application data, it can retrieve the tenant ID of the user device that the data originated from. The intelligence server 130 can aggregate the data according to tenant ID so that the data for each tenant ID can be presented exclusively to users of that tenant.

At stage 240, the intelligence server 130 can provide a GUI 142 to a device associated with the same tenant identifier, the GUI 142 displaying the application data associated with the tenant. For example, GUI engine 134 can receive the application data subsets and insert them into the GUI 142. The GUI engine 134 can also manage how the application data is displayed and who has access to which application data subset. For example, the GUI engine 134 can insert application data into the GUI 142 for each tenant ID that is only viewable by that tenant.

As an example, the GUI 142 can display information about the number of daily active users, monthly active users, and application loads. When a tenant user logs in to view the application data, the GUI engine 134 can provide a GUI 142 that displays the active users, monthly active users, and application loads corresponding to application data from user devices 110 of that tenant. For example, when the tenant user logs in to view the GUI 142, the tenant user can provide log-in credentials that are tied to a tenant ID for the tenant. The GUI engine 134 can provide a GUI 142 with application data for that tenant ID.

In an example, the GUI engine 134 can also create a view of the GUI 142 for the owner of the application 116 that includes additional data. This view can have administrative rights. For example, this admin version of the GUI 142 can display the active users, monthly active users, and application loads, as well as other metrics, for all the user devices. In one example, the admin GUI 142 can also allow an admin user to select a tenant, which would cause the GUI 142 to display that the selected tenant's data. In another example, the admin GUI 142 can also display additional information from the application data that is not viewable by the tenants. The data viewable only by admin users can be set by the admin. For example, an admin user can select to have the admin GUI 142 include crash rates, latency issues, and user behavior, but not have this information displayed in tenant GUIs 142.

In an example, the admin GUI 142 can allow an admin user to reconfigure the GUI 142. For example, the admin mode can allow an admin user to choose which application data and metrics are viewable for which tenants. The admin user can also modify metrics. For example, where the GUI 142 displays a user experience score based on various metrics of the application data, an admin user can modify the metrics used to determine the scores. For example, an admin user can change what application crash rate or latency rate is considered “good” versus “poor.”

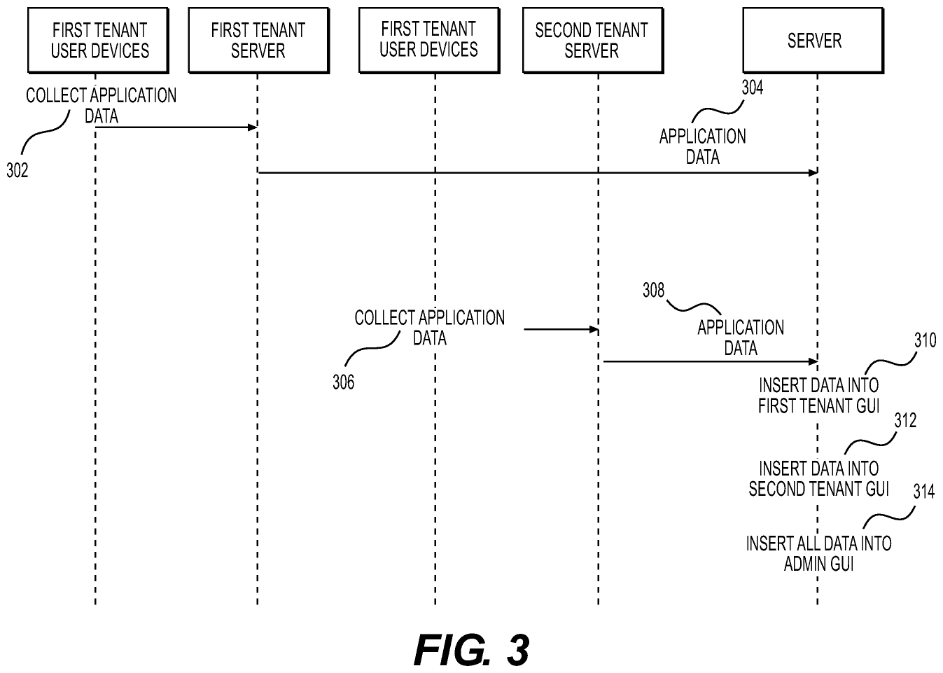

FIG. 3 is a sequence diagram of an example method for providing user experience data to tenants. At stage 302, a first group of user devices 110 can collect first application data. In an example, the first application data can include application performance data, usage data, user behavior data, and device health data. The first user devices 110 can be associated with a first tenant. For example, the first user devices 110 can be enrolled in a UEM under a first tenant. The first tenant can be a first client of the application 114, in an example. The management server 120 can provide a signed credential to the first user devices 110 when they enroll with the UEM, and the signed credential can include a tenant ID of the first tenant.

In an example, the application data can be collected by the intelligence agent 116 installed on the first user devices 110. In one example, the data can be collected as events. For example, the application 116 can log events that occur. The intelligence agent 116 can retrieve the logs and send them to a first tenant server associated with the first tenant. For example, when a first user device 110 is enrolled, the management server 120 can provide an endpoint URL for the first tenant server, which in an example can be an event proxy server. The intelligence agent 116 can send the collected application data to the first tenant server using the endpoint URL. In an example, the first tenant server can be a regional server associated with the tenant that is managed by the UEM. This can allow tenants to receive and view application data by geographic region.

In an example, the intelligence service 132 can send the application data as one or more a data files using an API call or an Internet protocol, such as HTTP, SOAP, REST, and/or other protocols.

At stage 304, the first tenant server can send the first application data to the intelligence server 130. In an example, the first tenant server can have a region ID based on the geographic location of user devices 110 that send application data to it. This can be based on enrollment settings set by an administrator, in an example.

In one example, the first user devices 110 can send the application data directly to the intelligence server 130, thus skipping stage 302. As an example, the signed credential can include a region ID that identifies the geographic region of the first user devices 110. The region ID can be used to filter application data presented in the GUI 142.

In an example, instead of sending the application data to the intelligence server 130, which can be a UEM server, the first tenant server can send the application data to an admin device associated with the owner of the application 114. For example, the application data can route from the first user devices 110 to the first tenant server, to the admin device, and then to the intelligence server 130. This can give the tenant and application owner access to application data from the first user devices 110. In one example, the UEM can manage what application can and cannot be read by each device. For example, the first tenant server can be given access to usage data, but not application performance data. The application owner device can be given access to the usage data as well as the application performance data.

At stage 306, a second group of user devices 110 can collect application data. The second group of user devices 110 can be associated with a second tenant. Like the first group of user device 110 above, the application data of the second user devices 110 can include application performance data, usage data, user behavior data, and device health data. The application data can be sent with a second tenant ID that associates the second user devices 110 with a second tenant. The second tenant ID can be included in a signed credential. The second application data can be collected by the intelligence agent 116.

The second user devices 110 can also send the application data to a second tenant server. The second device can be associated with the second tenant, such as a server. At stage 308, the second tenant server can send the second application data to the intelligence server 130. Like the first tenant server above, in one example, the second tenant server can send the application data to an owner device, which can then provide the application data to the intelligence server 130. In another example, the second user devices 110 can send the application data directly to the intelligence server 130. Routing the application data through the second tenant server and owner device can expose certain application data to the second data and application owner.

At stage 310, the intelligence server 130 can insert the first application data into a first tenant GUI 142. For example, the intelligence service 132 can receive the application data from both groups of user devices 110 and identify data corresponding to the first tenant using the provided tenant ID. The GUI engine 134 can insert the application data corresponding to the first tenant into the GUI 142 such that only user authorized for the first tenant's ID can view the application data. At stage 312, the intelligence server 130 can insert the second application data into a second tenant GUI 142 as well. If a user of the first tenant logs in to access the GUI 142, the first tenant user will see application data in the GUI 142 associated with only the first tenant. Likewise, a user of the second tenant can log in and view the GUI 142 with application data for the second tenant.

At stage 314, the intelligence server 130 can insert the first and second application data into an admin GUI 142. The admin GUI 142 can be a version of the GUI 142 that displays the application data for all tenants combined, allows a user to view each tenant's data individually, and allows a user to reconfigure the GUI 142 for tenant users. The admin GUI 142 can also display data unavailable to tenant users. For example, the admin GUI 142 can display detailed performance data regarding the application 114, such as crash rates, latency issues, handled exceptions, and user behavior. In one example, the admin GUI 142 can also include device health information. The application owner can use the performance data and device health data to determine how the application is performing and what changes may be needed. The tenants can use the GUI 142 to determine how frequently its users are using the application 114 and how the application 114 is performing for the users.

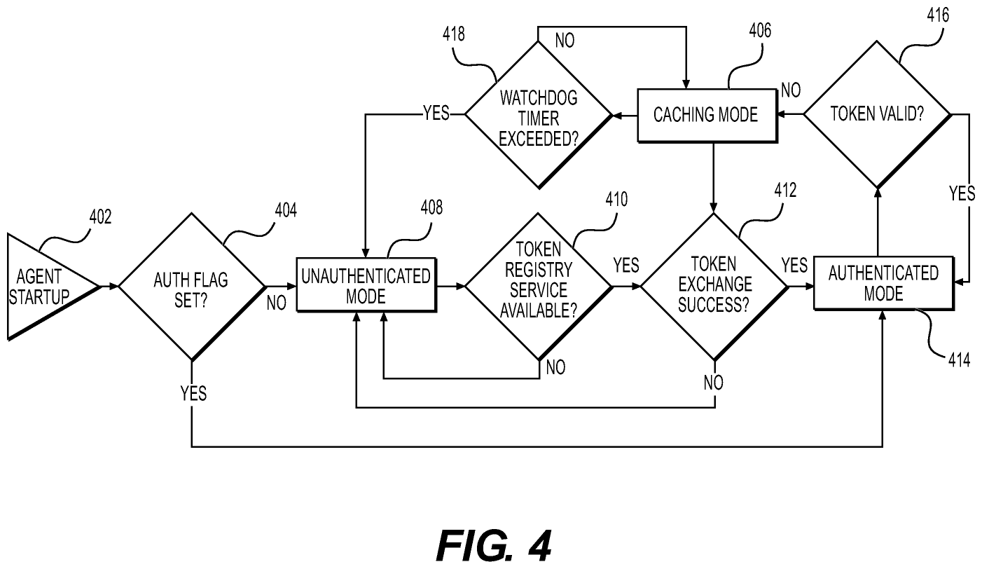

FIG. 4 is a second flowchart of an example method for providing user experience data to tenants that shows an operating mode of the intelligence agent 116. At stage 402, the intelligence agent 116 can initialize. In one example, the intelligence agent 116 can initialize when the user device 110 powers on. In another example, the management application 112 can initialize the intelligence agent 116.

At stage 404, the intelligence agent 116 can determine whether an authentication flag is set. The authentication flag can be a toggle that flips between an unauthenticated and authenticated mode depending on the success of a token exchange process to authenticate the user device 110. For example, the UEM can require that the intelligence agent 116 be authenticated before sending certain data, such as tenant related information. As an example, the application data can be routed to a server of the application owner or the UEM through a tenant server. The intelligence agent 116 can be required to authenticate before sending the application data to ensure that the application data is being routed through the correct tenant server so as not to expose data for the wrong tenant. Where the intelligence agent 116 cannot authenticate, the application data can be routed to an unauthenticated server that collects data that is not tenant specific.

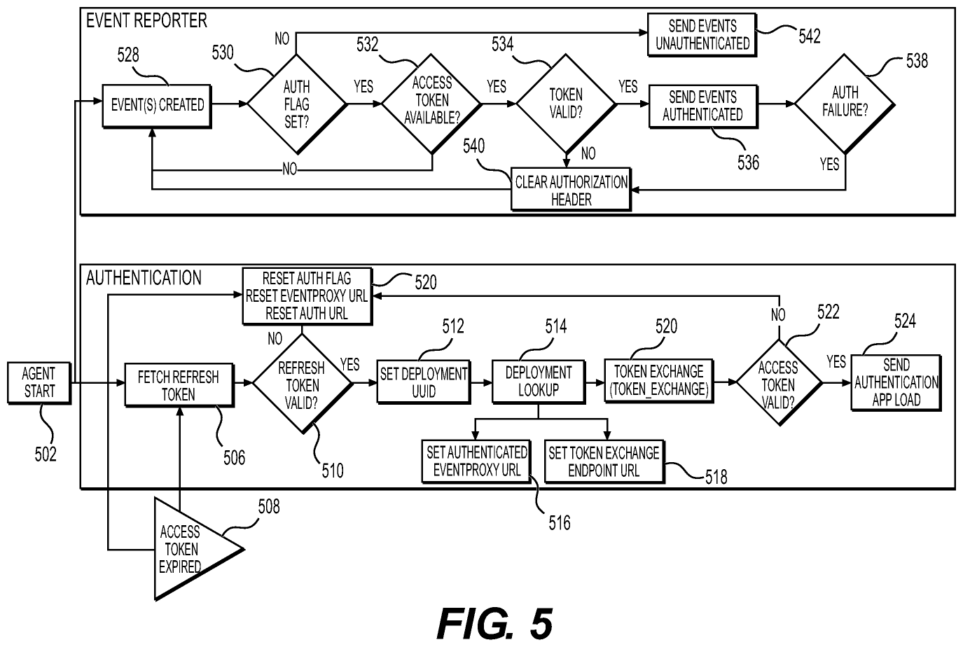

The token exchange process can include authenticating an endpoint where the intelligence agent 116 sends application data. Authenticating the endpoint can ensure that the application data is being sent to an authorized endpoint. An example of the token exchange process is described in greater detail regarding FIG. 5 later herein.

If the authentication flag is set, the intelligence agent 116 can proceed to stage 414 where it enters an authenticated mode. In the authenticated mode, the intelligence agent 116 can collect and send application data to the authorized endpoint.

If the authentication flag is not set, the intelligence agent 116 can proceed to stage 408 where it enters an unauthenticated mode. In unauthenticated mode, the intelligence agent 116 can send application data to an unauthenticated event proxy endpoint. However, because it is non authenticated, certain information can be withheld. For example, the intelligence agent 116 can send the application data without any information identifying the user device 110 or its corresponding tenant ID. In one example, the unauthenticated endpoint can be provided during the enrollment process as a backup for when the intelligence agent 116 is unable to enter authenticated mode.

In the unauthenticated mode, the intelligence agent 116 can determine whether a token registry service is available at stage 410. In an example, the token registry service can be a service that provides endpoint URLs and a valid access token in exchange for a valid refresh token from user devices 110. For example, a user device 110 can send a refresh token to the registry service. If the registry service can verify the refresh token, the registry service can respond with an access token and an event proxy endpoint where the intelligence agent 116 should send application data. A URL for contacting the registry service can be provided to the user device 110 during enrollment, in an example. In one example, the access token can be a signed credential that includes a tenant ID associated with the user device. In another example, the refresh token can be a signed JWT token.

At stage 412, if the token exchange with the registry service is successful, the intelligence agent can proceed to the authenticated mode at stage 414. The intelligence agent 116 can send the access token to the event proxy endpoint to authenticate and begin sending application data. If the token exchange is not successful, then the intelligence agent returns to stage 408 in unauthenticated mode and can again attempt to locate the registry service and exchange tokens.

At stage 416, the intelligence agent 116 can determine whether the access token is still valid. For example, the intelligence agent 116 can periodically check to ensure that the access token has not expired or that there has not been an authentication state change regarding the user device 110, such as the user device 110 being unenrolled. If the access token is still valid, the intelligence agent 116 can remain in authenticated mode. Otherwise, the intelligence agent 116 can proceed to stage 406 where it enters caching mode. In caching mode, the intelligence agent 116 can cache the application data on a local storage component of the user device 110. While in caching mode, at stage 418, the intelligence agent 116 can implement a watchdog timer. The watchdog timer can be a grace period where the intelligence agent 116 tries to reauthenticate the user device 110. If successful within the watchdog timer limit, the intelligence agent 116 can reenter authenticated mode and send the cached application data to the event proxy endpoint. If unsuccessful, the intelligence agent 116 can enter unauthenticated mode where it sends the application data to an unauthenticated event proxy endpoint.

FIG. 5 is a third flowchart of an example method for providing user experience data to tenants. Stages 502 through 526 are directed to the intelligence agent 116 authenticating the user device 110. At stage 502, the intelligence agent 116 can initialize. In one example, the intelligence agent 116 can initialize when a user powers on a user device 110. In another example, the management application 112 can initialize the intelligence agent 116.

At stage 506, the intelligence agent 116 can retrieve a refresh token. The refresh token can carry information necessary to get a new access token for sending application data to an authenticated endpoint. The refresh token can be saved on the user device 110, such in the management application 112. If no refresh token is found, the intelligence agent 116 can proceed to stage 526 where it resets the authentication flag to indicate that the user device 110 is not authenticated. It can also remove any saved endpoints, such as an authentication endpoint and event proxy endpoint.

At stage 508, the intelligence agent 116 can determine whether the refresh token is expired. If the refresh token is expired, the intelligence agent 116 can proceed to stage 526 to reset the authentication flag and endpoints. Similarly, at stage 510, the intelligence agent 116 can determine whether the refresh token is valid. If the refresh token is not valid, the intelligence agent 116 can proceed to stage 526 to reset the authentication flag and endpoints.

If the refresh token is current and valid, at stage 512 the intelligence agent 116 can set the deployment universally unique identifier (“UUID”). In an example, the deployment UUID can be a URL that the intelligence agent 116 can contact to obtain additional authentication and deployment information. In an example, the refresh token can be a JWT token provided by the management server 120. The refresh token can include the deployment UUID.

At stage 514, the intelligence agent 116 can contact the deployment endpoint. This can include providing the refresh token to the deployment endpoint. The deployment endpoint can verify the refresh token and respond with an authentication endpoint URL, a configuration endpoint URL, and an event proxy endpoint URL. Below is a sample deployment response.

```
{
  “data” : {
    “id” : “5bcde09c-707a-4c16-9dd3-0708f77922c3”,
    “name” : “United States (West Coast)”,
    “region” : “na1”,
    “endpoints” : {
      “api” : “api.na1.data.vmwservices.com”,
      “authentication” : “auth.na1.data.vmwservices.com”,
      “config” : “config.na1.data.vmwservices.com”,
      “eventproxy” : “eventproxy.na1.data.vmwservices.com”
    },
    “urls” : {
      “token_exchange” : “https://auth.na1.data.vmwservices.com/oauth/token”
    }
  }
}
```

The example response above includes information identifying the region of the endpoints. The “region” entry indicates “na1” as the region code, and all the endpoint URLs include “na1.” This can help ensure that application data is routed to the endpoints of the correct region. The region codes can also be used in providing the GUI 142. For example, if a tenant or application wishes to view application data in the GUI 142 for the United States, the GUI engine 134 can use the region code to insert data only from endpoints in the United States.

At stage 516, the intelligence agent 116 can set the authenticated event proxy URL. The authenticated event proxy URL can be set based on the deployment response. For example, using the example deployment response above, the intelligence agent 116 would set the authenticated even proxy endpoint URL to “eventproxy.na1.data.vmwservices.com.”

At stage 518, the intelligence agent 116 can set the token exchange endpoint URL. The token exchange endpoint URL can also be set based on the deployment response. For example, using the example deployment response above, the intelligence agent 116 would set the token exchange endpoint URL to “https://auth.na1.data.vmwservices.com/oauth/token.”

At stage 520, the intelligence agent 116 can exchange tokens with the token exchange endpoint. For example, the intelligence agent 116 can send the refresh token to the token exchange endpoint URL, which can be an authentication server. If the refresh is can authenticated, the token exchange endpoint can return an access token. In one example, the access token can be a signed credential that includes a tenant ID associated with the user device.

At stage 522, if the token exchange is unsuccessful, the intelligence agent 116 can reset the authentication flag and endpoints at stage 526. However, if the token exchange is successful, the intelligence agent 116 can proceed to stage 524 where it can configure the user device 110 according to the deployment response. For example, the intelligence agent 116 can set an authentication header, toggle the active event proxy URL, set an authentication flag, and begin sending application data to an authenticated endpoint. The authentication header can authenticate the intelligence agent 116 with the authenticated endpoint where it sends the application data. The active end proxy URL can be the URL the intelligence agent 116 uses to send application data to. For example, if the intelligence agent 116 is in an unauthenticated mode, the active end proxy URL can be an unauthenticated event proxy, and vice versa. The authentication flag can determine whether the intelligence agent 116 enters into authenticated or unauthenticated mode, such as the modes described regarding FIG. 4 above.

Stages 528 through 542 are directed to the intelligence agent 116 reporting events once authenticated using the stages described above. At stage 528, the intelligence agent 116 can receive an indication of an event. The indication can be a log entry of an event created by the application 114, in an example. For example, the application 114 can create an event for the application 114 loading, a CPU or memory usage measurement allocated to the application 114, the application 114 crashing, and other types of events.

At stage 530, the intelligence agent 116 can determine whether the authentication flag is set. If the authentication flag is not set, indicating that the intelligence agent 116 has not been able to exchange a refresh token for an access token, the intelligence agent 116 can send the event to an unauthenticated endpoint at stage 542. The intelligence agent 116 agent can send the unauthenticated events without the access token. These events therefore cannot be associated with a tenant.

If the authentication flag is set, at stage 532 the intelligence agent 116 can determine whether the access token is available. For example, the intelligence agent 116 can store the access token after exchanging tokens at stage 520. The access token can be required to authenticate the intelligence agent 116 when sending events to the authenticated event proxy endpoint. If the access token cannot be located, the intelligence agent 116 can return to stage 528. Alternatively, the intelligence agent 116 can send the event to the unauthenticated event proxy endpoint.

If the access token is available, then the intelligence agent 116 can check the validity of the access token at stage 534. If the access token is not valid, the intelligence agent 116 can clear the authentication header at stage 540. This can prevent the intelligence agent 116 from sending unauthenticated events to the authenticated event proxy endpoint. If the access token is valid, then the intelligence agent 116 can send the authenticated events to the authenticated even proxy endpoint at stage 536. The intelligence agent 116 can send the access token with the event for authentication purposes. If the authenticated event proxy endpoint rejects the access token for any reason, at stage 538 the intelligence agent 116 clear the authentication header. The intelligence agent 116 can then return to the authentication stages to try to obtain a valid access token.

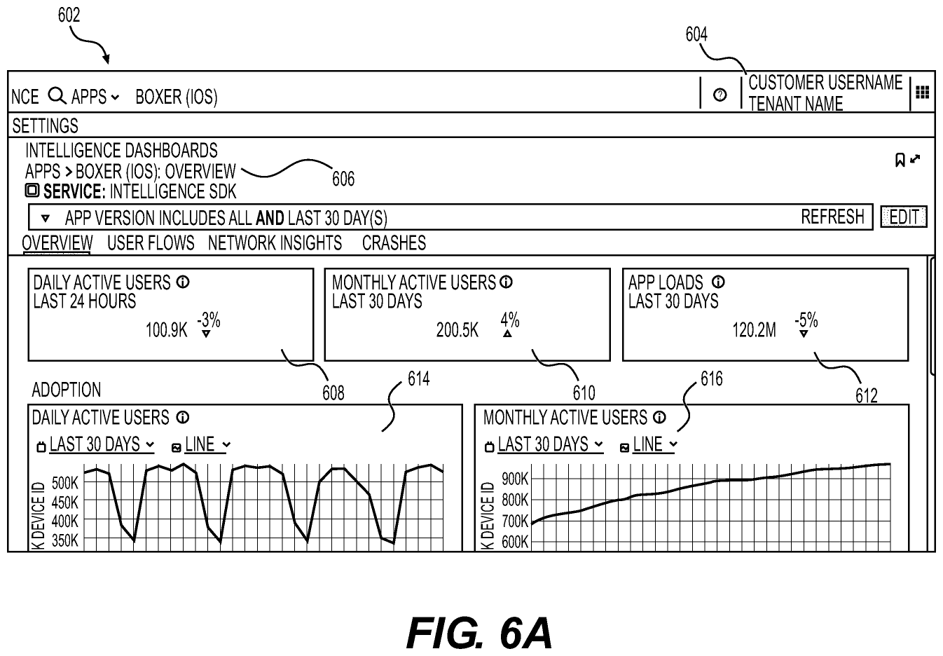

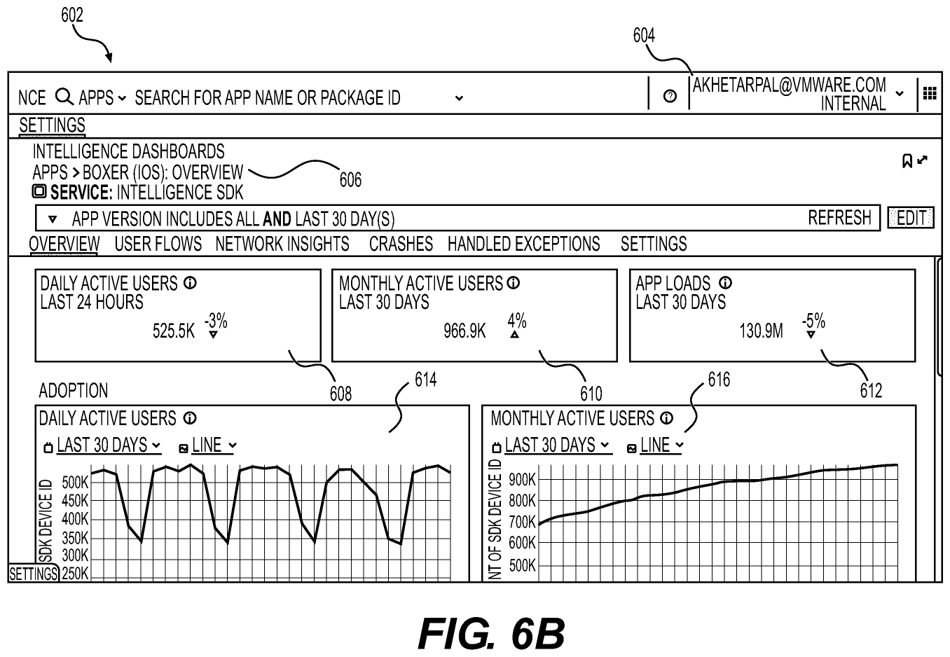

FIG. 6A is an illustration of an example GUI 602 of a display used to provide user experience data to tenants. The GUI 602 can be a tenant view of the GUI 142. The GUI 602 can include customer information 604. In an example, the customer information can include a username of the user logged into the GUI 602 and the name of the tenant whose data is being displayed in the GUI 602. In an example, the displayed customer information 604 can be a selectable drop-down. Selecting the customer information 604 can display a list of regions associated with the tenants. Selecting a region can display the application data for the tenant from user devices in the selected region. In one example, application data for tenants not in that region can be excluded from presentation.

The GUI 602 can also display the application name 606, which can be the name of the application of which the displayed data relates. In an example, the application name 606 can be a button element that, when selected by a user, displays other available applications that the user can view.

In an example, the GUI 602 can display various metrics from the performance data. For example, the GUI 602 illustrated in FIG. 6 displays daily active users 608, monthly active users 610, and application loads 612. Daily active users 608 displays the number of active users over the past 24 hours for the tenant. Monthly active users 610 displays the number of active users over the past 30 days for the tenant. Application loads 612 displays the number of times the application has been loaded on a user device 110 associated with the tenant over the past 30 days. The GUI 602 can of course display other metrics not shown in FIG. 6, such as crash rates and usage time.

The example GUI 602 also displays some metrics over time. For example, the daily active users graph 614 displays the number of daily active users over a time span. The GUI 602 can allow a user to select the time span, such as a week, day, or year. The example GUI 602 also includes a monthly active users graph 616 that displays the number of monthly active users over a time span. In one example, selecting one of the metrics 608, 610, or 612 can cause one of the graphs 614, 616 to display the selected metric over a time span.

FIG. 6B is an illustration of an example GUI 620 of a display used to provide user experience data to an application owner. In an example, the GUI 620 can be a version of the GUI 142 with admin access. The example GUI 620 displays the same information as the GUI 602, except the GUI 620 displays the application data for all users. For example, the daily active users 608, monthly active users 610, and application loads 612 display their respective data for all users of the application. Likewise, the graphs 614 and 616 can show a metric over time for all active users.

The GUI 620 can include a feature that allows the owner to view the application data by specific tenant. For example, the displayed customer information 604 can open a drop-down menu when selected by an admin user. The drop-down menu can display a list of tenants that use the application. The admin user can select a tenant, and the GUI 620 can change to display application data for that tenant.

In an example, the GUI 620 can display additional information and features not included in the GUI 602. For example, the GUI 620 can include a handled exceptions page 622 that displays resolved exceptions for the application. The GUI 620 can also include a settings page 624 that allows an admin user to customize the GUIs 602, 620. For example, an admin user can change how metrics are determined and what data is viewable by each tenant.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for providing user experience data to tenants, comprising:
receiving application data from an application executing on a plurality of user devices for multiple tenants, the application data including at least one of usage data, performance data, and user behavior data;
receiving, from each of the plurality of user devices, a signed credential that includes a tenant identifier identifying a tenant associated with the corresponding user device;
extracting a subset of the application data, the subset relating to user devices in the plurality having the same tenant identifier; and
providing a graphical user interface (“GUI”) that displays the application data associated with the tenant.

2. The method of claim 1, further comprising identifying, using the signed credential of each of the plurality of user devices, a geographic region associated with the corresponding user device, wherein the GUI includes an option to filter the application data by geographic region.

3. The method of claim 1, wherein the signed credential is an access token, the access token having been obtained by the plurality of user devices by exchanging a refresh token.

4. The method of claim 1, wherein the refresh token is a JavaScript Object Notation Web Token (“JWT”).

5. The method of claim 1, wherein the usage data includes at least one of daily active users, monthly active users, and application loads.

6. The method of claim 1, the performance data includes at least one of crash rates, network calls, network error rates, and performance of a virtual private network.

7. The method of claim 1, wherein the user behavior data includes interaction data identifying key interactions between users and the application, the interaction data having been collected from an agent installed on the plurality of user devices.

8. A non-transitory, computer-readable medium containing instructions that, when executed by a hardware-based processor, performs stages for providing user experience data to tenants, the stages comprising:
receiving application data from an application executing on a plurality of user devices for multiple tenants, the application data including at least one of usage data, performance data, and user behavior data;
receiving, from each of the plurality of user devices, a signed credential that includes a tenant identifier identifying a tenant associated with the corresponding user device;
extracting a subset of the application data, the subset relating to user devices in the plurality having the same tenant identifier; and
providing a graphical user interface (“GUI”) that displays the application data associated with the tenant.

9. The non-transitory, computer-readable medium of claim 8, the stages further comprising identifying, using the signed credential of each of the plurality of user devices, a geographic region associated with the corresponding user device, wherein the GUI includes an option to filter the application data by geographic region.

10. The non-transitory, computer-readable medium of claim 8, wherein the signed credential is an access token, the access token having been obtained by the plurality of user devices by exchanging a refresh token.

11. The non-transitory, computer-readable medium of claim 8, wherein the refresh token is a JavaScript Object Notation Web Token (“JWT”).

12. The non-transitory, computer-readable medium of claim 8, wherein the usage data includes at least one of daily active users, monthly active users, and application loads.

13. The non-transitory, computer-readable medium of claim 8, the performance data includes at least one of crash rates, network calls, network error rates, and performance of a virtual private network.

14. The non-transitory, computer-readable medium of claim 8, wherein the user behavior data includes interaction data identifying key interactions between users and the application, the interaction data having been collected from an agent installed on the plurality of user devices.

15. A system for providing user experience data to tenants, comprising:
a memory storage including a non-transitory, computer-readable medium comprising instructions; and
a computing device including a hardware-based processor that executes the instructions to carry out stages comprising:
receiving application data from an application executing on a plurality of user devices for multiple tenants, the application data including at least one of usage data, performance data, and user behavior data;
receiving, from each of the plurality of user devices, a signed credential that includes a tenant identifier identifying a tenant associated with the corresponding user device;
extracting a subset of the application data, the subset relating to user devices in the plurality having the same tenant identifier; and
providing a graphical user interface (“GUI”) that displays the application data associated with the tenant.

16. The system of claim 15, the stages further comprising identifying, using the signed credential of each of the plurality of user devices, a geographic region associated with the corresponding user device, wherein the GUI includes an option to filter the application data by geographic region.

17. The system of claim 15, wherein the signed credential is an access token, the access token having been obtained by the plurality of user devices by exchanging a refresh token.

18. The system of claim 15, wherein the refresh token is a JavaScript Object Notation Web Token (“JWT”).

19. The system of claim 15, wherein the usage data includes at least one of daily active users, monthly active users, and application loads.

20. The system of claim 15, the performance data includes at least one of crash rates, network calls, network error rates, and performance of a virtual private network.
